(19) United States
(12) Patent Application Publication
(10) Pub. No.: US 2007/0263276 A1
(43) Pub. Date: Nov. 15, 2007

(54) DISPLAY DEVICE, MANUFACTURING METHOD OF DISPLAY DEVICE, AND ELECTRONIC APPARATUS

(75) Inventor: Yoshiki Takei, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/739,719

(22) Filed: Apr. 25, 2007

(30) Foreign Application Priority Data
Apr. 26, 2006 (JP) 2006-121667
Feb. 15, 2007 (JP) 2007-035145

(51) Int. Cl. G02B 26/00

(52) U.S. Cl. 359/296

(57) ABSTRACT

A display device equipped with a display body having a curved surface shape. A front surface and a back surface of the display body are covered by a contiguous waterproof membrane.

### BACKGROUND

1. Technical Field

Several aspects of the present invention relate to a display device, a manufacturing method of a display device, and an electronic apparatus.

2. Related Art

An electrophoresis display device has been drawn attention as a display device which is superior in lightweight properties, bendability, low power consumption, and the like. The electrophoresis display device has a property in which display quality is hardly influenced by distortion, so that the electrophoresis display device is suitable to be used as a display device having a curved surface shape. Accordingly, application for operation display along a curved appearance surface of a watch, an electronic apparatus, and the like, and the like in which these characteristics are used has been expected.

The electrophoresis display device has a structure in which an electrophoresis layer formed by a dispersion medium including electrophoresis particles is interposed between a transparent substrate having a transparent electrode layer and a substrate equipped with a pixel electrode provided so as to oppose the transparent electrode layer, a pixel driving circuit, and the like. When moisture is invaded into the electrophoresis layer, there is a problem in that the property thereof is decreased and the display performance is reduced. Accordingly, there is needed to provide a sealing structure for preventing the invasion of moisture.

A technique of a waterproof structure of the electrophoresis display device is disclosed, for example, in JP-A-2005-114820.

However, in the case of a display device having a curved surface shape, formation of a waterproof membrane along the curved surface often causes wrinkles in the waterproof membrane. In addition, when a curvature of the curved surface is too large, keeping the adhesiveness between the waterproof membrane and the display body is difficult.

### SUMMARY

An advantage of some aspects of the invention is that a waterproof structure of a display device having a curved surface is easily formed with high accuracy.

The display device of an aspect the invention is equipped with a display body having a curved surface shape. A front surface and a back surface of the display body are covered by a contiguous waterproof membrane. Herewith, the waterproof membrane of the display body is integrally formed, so that waterproof property can be maintained even for a display body having a curved surface shape having a large curvature.

Further, the display body has an area which is not covered by the waterproof membrane. The waterproof membrane covers the display body so as to wrap long sides of the display body, and the back surface has an area which is not covered by the waterproof membrane.

The display body may shall include a first electrode and a second electrode oppositely disposed and a dispersion system including electrophoresis particles provided between the first electrode and the second electrode.

A manufacturing method of a display device according to another aspect of the invention includes fixing a display body having a curved surface shape to an inside member of a shaping die having a curved surface shape having a curvature approximately equivalent to that of the curved surface shape, inserting the inside member to which the display body is fixed into an outside member of the shaping mold having a concave portion having a shape approximately equivalent to the inside member, pouring a low temperature cure resin into a space formed between the display body fixed to the inside member and an inner wall of the outside member and curing the resin, and taking out the display body from the shaping die.

Another aspect of the invention is a manufacturing method of a display device using a display body having a curved surface shape using a shaping die constituted by an inside member and an outside member. The inside member has an outside surface having a curvature approximately equivalent to that of the curved surface shape, and the outside member has a concave portion having an inner wall having a shape approximately equivalent to the outside surface of the inside member. The manufacturing method includes the steps of (a) fixing the display body to the outside surface of the inside member, (b) inserting the inside member to which the display body is fixed into the concave portion of the outside member so that the display body and the inner wall of the outside member are opposed, (c) pouring a low temperature cure resin into a space sandwiched by the outside surface of the inside member and the inner wall of the concave portion formed in the state where the inside member to which the display body is fixed is inserted and curing the resin, and (d) taking out the display body covered by the cured low temperature cure resin from the shaping die after the low temperature cure resin is cured.

Herewith, the waterproof membrane of the display body can be integrally formed by using the shaping mold, so that the waterproof membrane can be formed by an easy method, to have high adhesiveness, and with high accuracy even for a waterproof membrane of the display body having a curved surface shape having a large curvature.

Further, it is desirable that the inside member has an area contacts the display body and an area, a space is provided between the area and the display body, in the sticking surface of the display body. Herewith, the display body becomes easy to be taken out from the shaping die.

Further, it is preferable that the outside surface of the inside member has an area which contacts the display body and an area which does not contact the display body.

Herewith, the low temperature cure resin is also poured into a space formed by the inside member and the area in which the display body does not contact, so that the waterproof membrane can be formed so as to wrap the display body from the front surface to the back surface.

In step (c), in the step for pouring the low temperature cure resin and curing the resin, it is desirable that the low temperature cure resin is heated to 120 degree C. by spending five hours, left for four hours at 120 degree C., and then returned to ordinary temperature.

Further, it is desirable that the step (d) includes cooling to contract the inside member and heating to expand the outside member and thereby isolating the display body placed to the inside member from the inner wall of the outside member.

Further, it is desirable that the inside member is formed by a row material having a heat conductivity higher than that of the outside member.

Herewith, the inside member can be easily taken out from the outside member of the shaping die.

Further, an electronic apparatus of another aspect of the invention is equipped with the display device described above or the display device manufactured by the manufacturing method of a display device described above as a display unit. Herein, the electronic apparatus includes a watch, a mobile phone, a personal digital assistance, a memory apparatus for storing music or image, an electronic apparatus equipped with a curved surface display such as a display panel of a printer or home electric appliances, and the like. Further, the one which is not included in the conception of the “apparatus”, for example, an object having a flexibility in a state of a paper of film, the one belonging to real estate such as a wall surface or the like on which the object is attached, and the one belonging to a movable body such as a car, an airplane, a ship, or the like is also included.

### BRIEF DESCRIPTION OF THE DRAWINGS

The invention will be described with reference to the accompanying drawings, wherein like numbers reference like elements.

FIG. 1 is a perspective view showing a display body of a display device according to the invention.

FIG. 2 is a perspective view showing an inside member of a shaping die.

FIG. 3 is a diagram showing a method for inserting the inside member of the shaping die to which the display body is fixed into an outside member of the shaping die.

FIG. 4 is a diagram showing a method for inserting the inside member of the shaping die to which the display body is fixed into the outside member of the shaping die.

FIG. 5 is a diagram showing a state in which the inside member of the shaping die to which the display body is fixed is inserted into the outside member of the shaping die.

FIG. 6 is a cross sectional view taken along line VI-VI of FIG. 5.

FIG. 7 is a cross sectional view showing the display body after a waterproof membrane is formed.

FIG. 8 is an overhead view of the inside member of the shaping die to which the display body is fixed according to another example of the first embodiment.

FIG. 9 is a cross sectional view showing a state in which the inside member of the shaping die to which the display body is fixed is inserted into the outside member of the shaping die according to another example of the first embodiment.

FIG. 10 is a diagram showing an example of an electronic apparatus according to the invention.

### DESCRIPTION OF EXEMPLARY EMBODIMENTS

Hereinafter, an embodiment of the invention will be described with reference to the accompanying drawings.

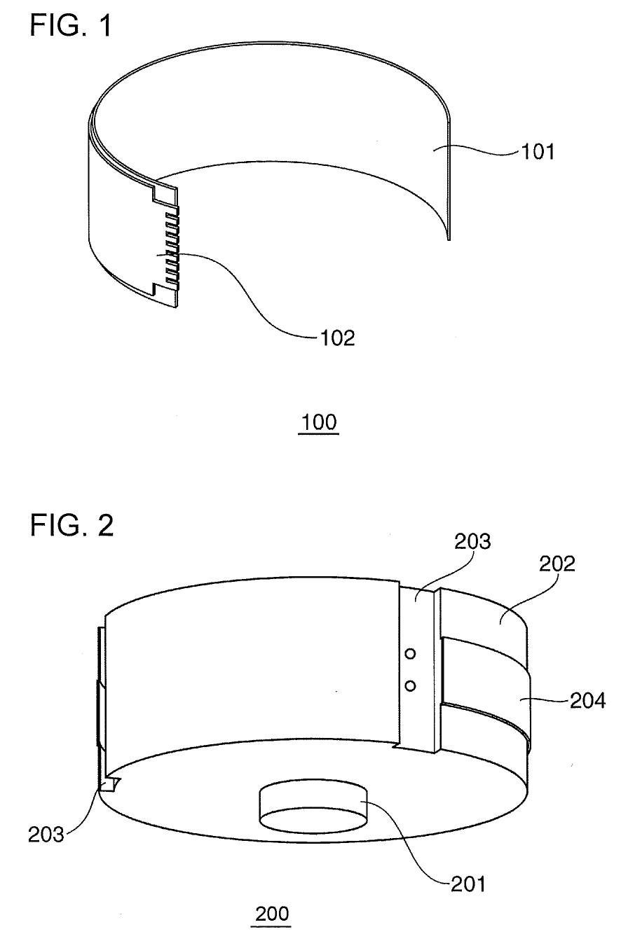

FIG. 1 is a cross sectional view showing a display body 100 of a display device according to the invention. As shown in FIG. 1, the display body 100 includes a base material 101 and a display module 102 attached to the base material 101. The base material 101 and the display module 102 have an almost same curved surface shape. It is desirable that the base material 101 is formed by a raw material having moisture resistance, gas-barrier property (ethylene system, ABS, PC, PET, PP, or the like).

The display module 102 is, for example, an electrophoresis display module. The electrophoresis display module is constructed by enclosing a dispersion liquid for electrophoresis display between a first electrode and a second electrode. The dispersion liquid for electrophoresis display includes one or plurality colors of electrophoresis particles and an electrophoresis dispersion medium. At least one of the first electrode and the second electrode is a transparent electrode using, for example, ITO film (indium oxide film in which tin is doped) or the like. The electrophoresis particles are moved in the electrophoresis dispersion medium by applying a voltage between the two electrodes to change the existence positions thereof, thereby displaying information. Note that, in order to form the curved surface shape as shown in FIG. 1, the first electrode and the second electrode are formed by using flexible substrates which are rich in flexibility such as a plastic material or the like.

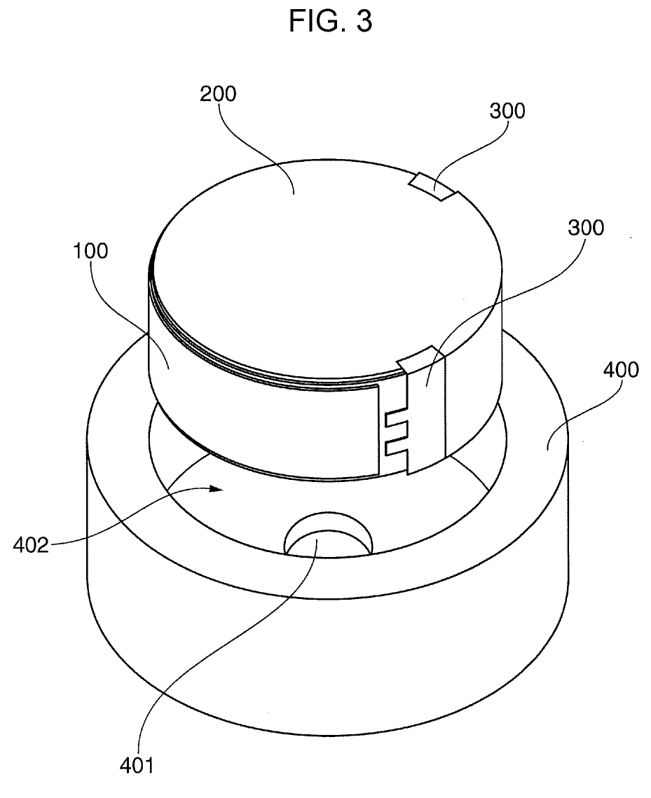

FIG. 2 is a diagram showing an inside member 200 of a shaping die used for coating a waterproof membrane on the front surface (display module 102 side) and the back surface (base material 101 side) of the display body 100 shown in FIG. 1. As shown in FIG. 2, the inside member 200 has a cylindrical shape and has a fitting portion 201 with an outside member of the shaping die at one bottom surface. Further, a sticking portion 202 of the display body 100 and two fixing portions 203 of the display body 100 are provided on the side surface. The sticking portion 202 is formed in a curved surface shape having a curvature approximately equivalent to that of the display body 100. Further, a convex portion 204 is formed on the sticking portion 202. The convex portion 204 contacts the base material 101 when the display body 100 is stuck with the sticking portion 202, so that a waterproof membrane will not be coated on the contact zone.

The inside member 200 of the shaping die is formed by a material having a high heat conductance such as a metal or the like. This is because, as described below, when the display body 100 is taken out from the shaping die, the inside member 200 of the shaping die becomes easy to be taken out from the outside member.

FIG. 3 is a diagram showing a method for inserting the inside member 200 of the shaping die to which the display body 100 is fixed into the outside member 400 of the shaping die. As shown in FIG. 3, the outside member 400 of the shaping die has a cylindrical structure having a concave portion 402 having the shape approximately equivalent to the inside member 200 of the shaping die and has an fitting portion 401 with the inside member at one bottom surface. The other bottom surface is to be an opening.

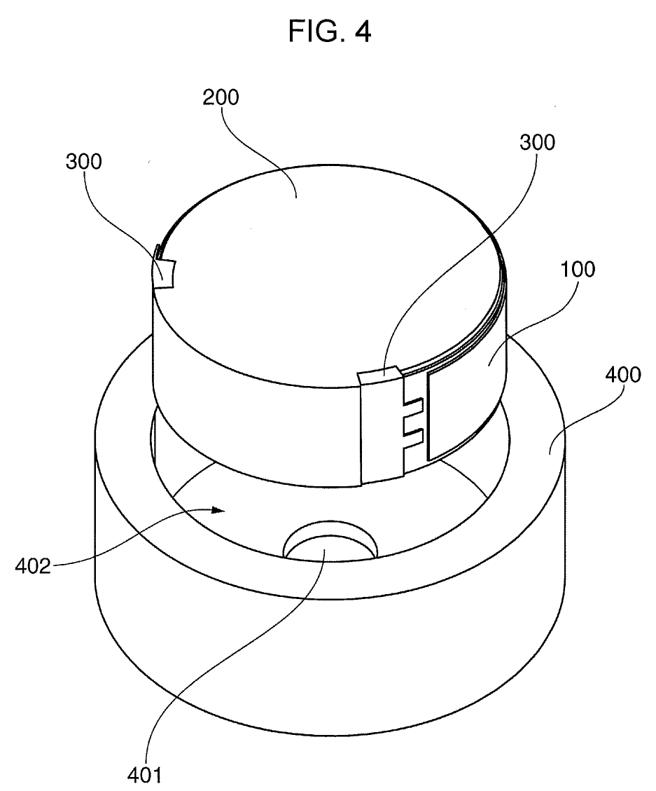

As shown in FIG. 3, the display body 100 is placed in the fixing portions 203 of the inside member 200 of the shaping die with fixing members 300. Note that, the base material 101 contacts the surface of the inside member 200, and the surface of the display module 102 side is exposed. The inside member 200 of the shaping die is inserted into the outside member 400 by fitting the fitting portion 201 with the fitting portion 401 of the outside member 400. Further, FIG. 4 is a diagram in which FIG. 3 is viewed from another direction.

The outside member 400 of the shaping die may be formed by a material such as a glass, a metal, or the like.

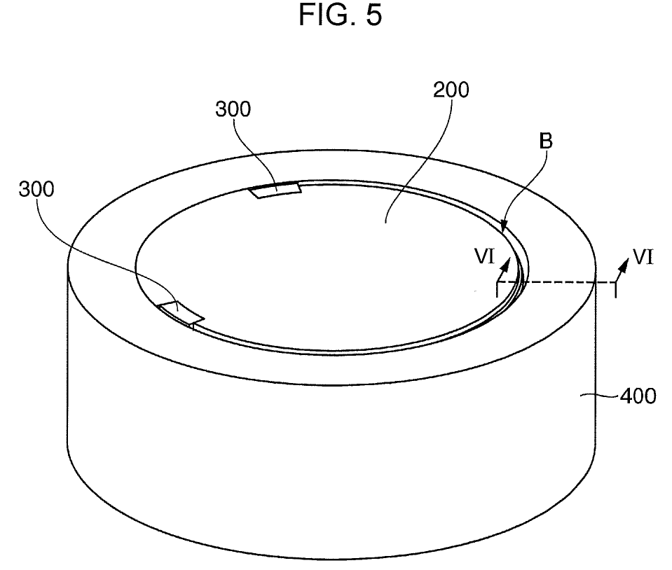

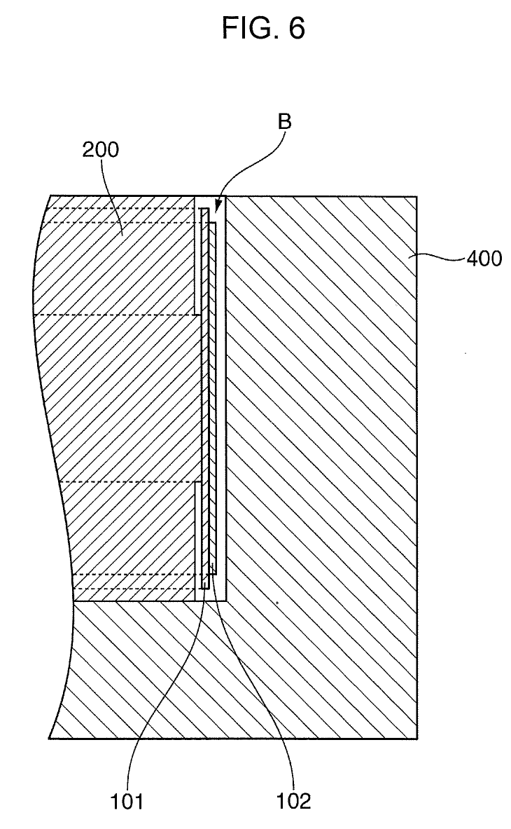

FIG. 5 is a diagram showing a state in which the inside member 200 of the shaping die to which the display body 100 is fixed is inserted into the outside member 400 of the shaping die. Further, FIG. 6 is a cross sectional view taken along line VI-VI of FIG. 5.

As shown in FIGS. 5 and 6, a space (B in the drawings) is formed between the display module 102 of the display body 100 and the inner wall of the outside member 400 of the shaping die. A low temperature cure resin is poured into the space. As for the low temperature cure resin, for example, besides an epoxy system resin, a styrene series polymer, an acrylic polymer, a macromer polymer, or the like can be used.

After the resin is poured, the resin is left or depressurized for about half a day for degassing, thereafter heated by spending a long time to raise the temperature to about 120 degree C. It is desirable for applying the heat for five hours. Further, the resin is left for about four hours in the state of 120 degree C., and then, gradually returned to the ordinary temperature.

Next, the display body 100 is taken out from the shaping die. When taking out, first, the inside member 200 to which the display body 100 is fixed is taken out from the outside member 400. At this time, by cooling the inside member 20 and heating the outside member 400, the outside member 400 expands and the inside member 200 contracts, so that taking out becomes easy. Preferably, the inside member 20 is formed by a row material having a high heat conductivity. Further, by putting a release paper on the bottom surface of the outside member 400 of the shaping die in advance, the taking out becomes easy. Next, the display body 100 is detached from the inside member 200 of the shaping die.

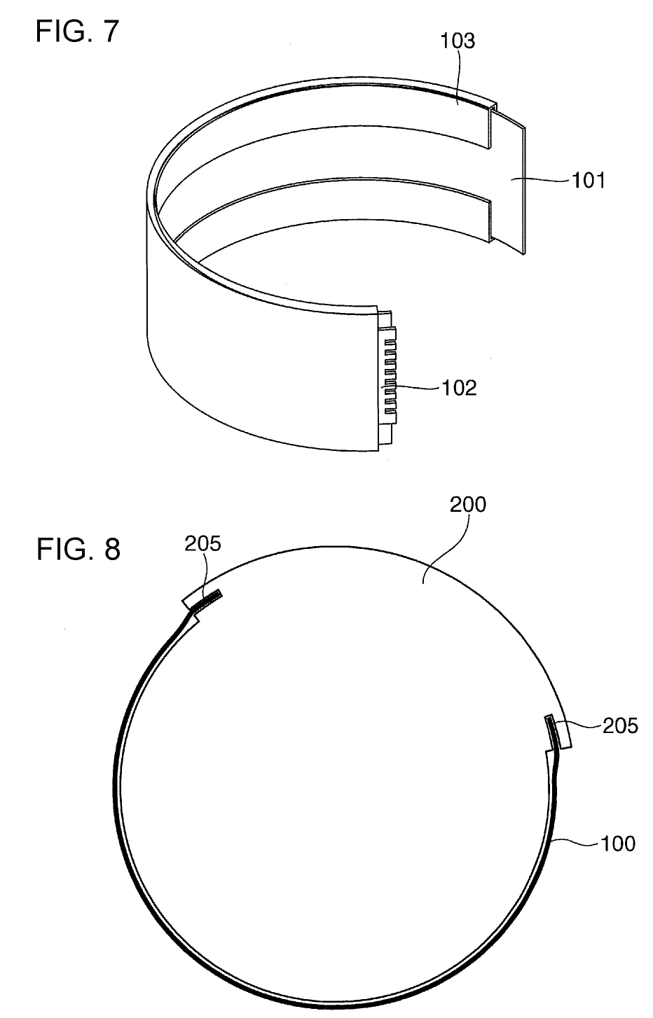

FIG. 7 is a perspective view showing the display body 100 taken out from the inside member 200 after the waterproof membrane 103 is formed. As shown in FIG. 7, a center portion of the back surface of the base material 101 side is not covered by the waterproof membrane 103. This is the area to which the convex portion 204 of the inside member 200 of the shaping die was contacted. By providing such an area, besides positioning and fixing to a jig becomes possible, there is an advantage in that the display body 100 becomes easy to be taken out from the shaping die.

In this manner, according to the first embodiment, a contiguous waterproof membrane having a high adhesiveness and a high accuracy can be formed by an easy method even for a waterproof membrane of the display body 100 having a curved surface shape having a large curvature by integrally forming the waterproof membrane 103 of the display body 100 by using the shaping die.

In the first embodiment, the fixing members 300 are used to fix the display body 100 when placing to the inside member 200. However, not that, for example, as shown in FIG. 8, edge portions of the display body 100 may be inserted into the spaces provided to the inside member 200. Note that, FIG. 8 is an overhead view of the inside member 200 of the shaping die to which the display body 100 is fixed. The edge portions of the display body 100 are fixed to the inserting portions 205 provided to the inside member 200 of the shaping die.

This method is available in the case where the edge portions of the display body 100 needs to be remained as for a connecting portion for power supply, or the like.

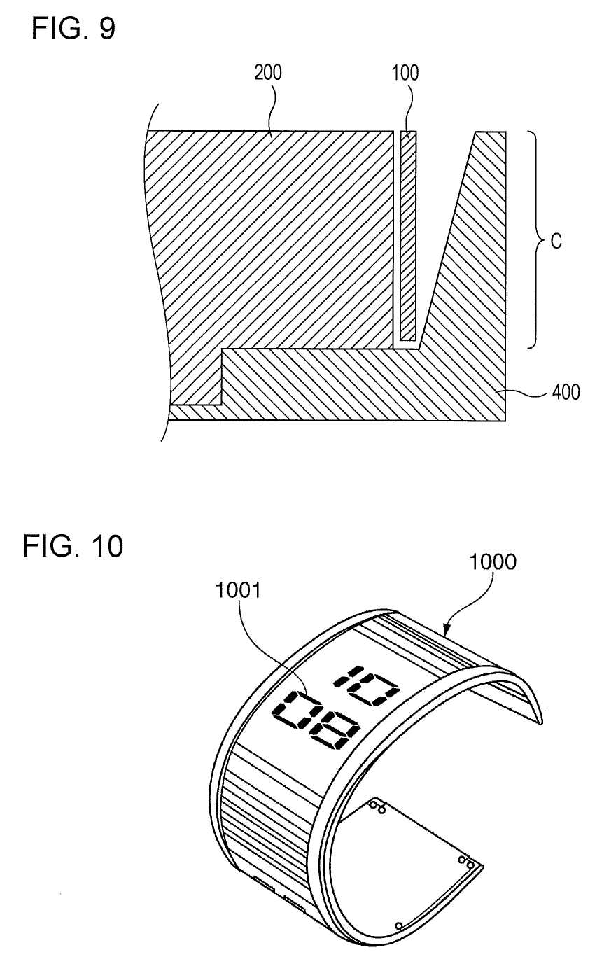

Further, the side wall (C portion in FIG. 9) of the outside member 400 of the shaping die may be a tapered shape whose thickness increase toward the lower direction as shown in FIG. 9. With such a shape, the inside member 200 becomes easy to be taken out from the outside member 400.

Further, it is desirable that the inside surface of the side wall of the outside member 400 of the shaping die is subjected to a mirror finish. Herewith, there is an advantage in that the finish of the surface of the display body 100 at the display surface side becomes well.

### Electronic Apparatus

FIG. 10 is a perspective view showing a bracelet type watch 1000 which is an example of an electronic apparatus equipped with the display device of the invention. The watch 1000 is equipped with a display unit 1001 formed by using the display device according to the invention. As shown in FIG. 10, the display unit 1001 has a curved surface shape. Besides, as for examples of the electronic apparatus, there are included a mobile phone, a personal digital assistance, and the like having a display unit constructed by using the display device according to the invention.

What is claimed is:

1. A display device equipped with a display body having a curved surface shape,
a front surface and a back surface of the display body being covered by a contiguous waterproof membrane.

2. The display device according to claim 1, wherein
the waterproof membrane covers the display body so as to wrap long sides of the display body, and
the back surface has an area which is not covered by the waterproof membrane.

3. The display device according to claim 1, wherein the display body includes a first electrode and a second electrode oppositely disposed and a dispersion system including electrophoresis particles provided between the first electrode and the second electrode.

4. An electronic apparatus equipped with the display device according to claim 1.

5. A manufacturing method of a display device using a display body having a curved surface shape using a shaping die constituted by an inside member and an outside member,
wherein
the inside member has an outside surface having a curvature approximately equivalent to that of the curved surface shape, and
the outside member has a concave portion having an inner wall having a shape approximately equivalent to the outside surface of the inside member, and comprising the steps of:
(a) fixing the display body to the outside surface of the inside member;
(b) inserting the inside member to which the display body is fixed into the concave portion of the outside member so that the display body and the inner wall of the outside member are opposed;
(c) pouring a low temperature cure resin into a space sandwiched by the outside surface of the inside member and the inner wall of the concave portion formed in the state where the inside member to which the display body is fixed is inserted and curing the resin; and
(d) taking out the display body covered by the cured low temperature cure resin from the shaping die after the low temperature cure resin is cured.

6. The manufacturing method of a display device according to claim 5, wherein the outside surface of the inside member has an area which contacts the display body and an area which does not contact the display body.

7. The manufacturing method of a display device according to claim 5, wherein in step (c), the low temperature cure resin is heated to 120 degree C. by spending five hours, left for four hours at 120 degree C., and then returned to ordinary temperature.

8. The manufacturing method of a display device according to claim 5, wherein the step (d) includes cooling to contract the inside member and heating to expand the outside member and thereby isolating the display body placed to the inside member from the inner wall of the outside member.

9. The manufacturing method of a display device according to claim 5, wherein the inside member is formed by a row material having a heat conductivity higher than that of the outside member.

10. An electronic apparatus equipped with a display device manufactured by the manufacturing method of a display device according to claim 5.
